(19) United States
(12) Patent Application Publication
(10) Pub. No.: US 2026/0089514 A1
(43) Pub. Date: Mar. 26, 2026

(54) MESH ACCESS POINT PLACEMENT FOR A WIRELESS MESH NETWORK

(71) Applicant: QUALCOMM Incorporated, San Diego, CA (US)

(72) Inventors: Xiaolong HUANG, Santee, CA (US); Srinivas KATAR, Fremont, CA (US); Bhaskara PEELA, Fremont, CA (US); Sandip HomChaudhuri, San Jose, CA (US)

(21) Appl. No.: 18/895,233

(22) Filed: Sep. 24, 2024

(51) Int. Cl. H04W 16/18; H04W 16/26; H04W 84/18

(52) U.S. Cl. CPC H04W 16/18; H04W 16/26; H04W 84/18

(57) ABSTRACT

This disclosure provides methods, components, devices and systems for providing location recommendations for placing mesh radio nodes in a physical service environment. In some examples, a spatial representation is generated using sensor data of the scanned physical service environment. The spatial representation is utilized to determine a recommended location for placement of the mesh radio nodes or mesh access points (APs) for a wireless network in the physical service environment. In some examples, the recommended location is outputted as a placement diagram or map, indicating the recommended location of the mesh APs.

### TECHNICAL FIELD

Various aspects relate generally to wireless mesh communication networks and more particularly to providing location recommendations for placing mesh radio nodes in a physical service environment.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a device, including a network device. In some aspects, the techniques described herein relate to a device, including: a processing system that includes one or more processors and one or more memories coupled with the one or more processors, the processing system configured to cause the device to: receive sensor data based on a scan of a physical service environment using at least one optical sensor associated with the device, a spatial representation representing the physical service environment being generated based on the sensor data, receive information indicating at least one candidate node location in the spatial representation for a root access point (AP) of a wireless network, receive information indicating at least one coverage area for the wireless network within the spatial representation, and output information indicating a recommended location of at least one mesh AP of the wireless network within the spatial representation, where the recommended location of the at least one mesh AP of the wireless network within the spatial representation is based at least in part on the at least one candidate node location of the root AP, the at least one coverage area for the wireless network, and physical properties of the physical service environment.

In some examples, the processing system is further configured to cause the device to: scan the physical service environment, using the at least one optical sensor associated with the device, to collect the sensor data representing the physical service environment, and generate the spatial representation for the physical service environment using the sensor data.

In some examples, the at least one optical sensor includes one or more of: a light detection and ranging (LIDAR) sensor, or image sensor.

In some examples, the spatial representation for the physical service environment includes representations of one or more of: candidate locations to connect to a wide area network (WAN), candidate power source locations, or physical obstacles.

In some aspects, where the processing system is further configured to cause the device to: receive information indicating expected areas of high wireless network demand, where candidate client anchor locations are added to the spatial representation based on the expected areas of high wireless network demand, and where the recommended location of the at least one mesh AP is based at least in part on the expected areas of high wireless network demand.

In some examples, to determine the recommended location of the at least one mesh AP the processing system is further configured to cause the device to: select, using service factors for the wireless network, a set of placement parameters for positioning the at least one mesh AP in the physical service environment, generate, using the set of placement parameters, the at least one coverage area, and physical properties of the physical service environment, a plurality of AP placement combinations, where each AP placement combination includes a location in the spatial representation for the root AP and the at least one mesh AP, generate a network performance score for each of the plurality of AP placement combinations, and select an AP placement combination with a highest network performance score as an AP placement configuration for the physical service environment, where the AP placement configuration with the highest network performance score includes the recommended location of the at least one mesh AP within the spatial representation.

In some examples, to generate the plurality of AP placement combinations the processing system is further configured to cause the device to: select a root node AP location for a first AP placement combination of the plurality of AP placement combinations using the candidate root node locations and candidate power source locations, and select at least one repeater node AP location for the first AP placement combination using the candidate power source locations and candidate client anchor locations.

In some examples, to generate the network performance score for each of the plurality of AP placement combinations the processing system is further configured to cause the device to: select an unscored AP placement combination of the plurality of AP placement combinations, estimate a number of clients able to connect to the wireless network when the unscored AP placement combination is deployed in the physical service environment, estimate end-to-end traffic performance for the number of clients, estimate an overall network traffic throughput, and generate the network performance score for the unscored AP placement combination using the number of clients, the end-to-end traffic performance and the overall network traffic throughput.

In some examples, the recommended location of the at least one mesh AP within the spatial representation is further based at least in part on at least one of: an expected number of client devices connected to the wireless network, an expected overall network traffic demand for the wireless network, an expected network traffic demand for one or more client devices connected to the wireless network, or a number of mesh APs available for placement in the physical service environment.

In some aspects, the processing system is further configured to cause the device to: receive a selection of a placement parameter preference for the wireless network, where the placement parameter preference includes one or more of: select mesh AP candidate locations that increase a minimum throughput for an expected overall network traffic demand for the wireless network, select mesh AP candidate locations that increase a capacity of client devices connected to the wireless network, select mesh AP candidate locations that satisfy an expected network traffic demand for the one or more client devices connected to the wireless network, select mesh AP candidate locations that utilize a number of mesh APs for placement in the physical service environment, or exclude mesh AP candidate locations that create constrained network traffic pathways, where the recommended location of the at least one mesh AP is based at least in part on the placement parameter preference.

In some examples, the processing system is further configured to cause the device to: receive an indication that the at least one mesh AP is positioned in a recommended physical location corresponding to the recommended location of the at least one mesh AP within the spatial representation, measure at least one observed network performance parameter of the wireless network associated with the positioned at least one mesh AP, and at least one of: update the recommended location of the at least one mesh AP within the spatial representation based at least in part on the observed network performance parameter, or output information indicating another recommended location of another mesh AP within the spatial representation based at least in part on the observed network performance parameter.

In some examples, measuring at least one network performance parameter of the wireless network associated with the positioned at least one mesh AP includes: associate a device location of the device within the physical service environment with an associated coverage area of the at least one coverage area in the spatial representation, test a network connection between the device at the device location and the wireless network to generate the at least one observed network performance parameter, and update a network performance score associated with the at least one coverage area of the recommendation location with the at least one observed network performance parameter.

In some examples, the at least one network performance parameter includes one or more of: a Received Signal Strength Indicator (RSSI) measurement, available wireless channels in the wireless network, a number of devices connected to the wireless network, and network traffic demand of connected devices.

Another innovative aspect of the subject matter described in this disclosure can be implemented in a method In some aspects, the method includes: receiving sensor data based on a scan of a physical service environment using at least one optical sensor associated with a device, a spatial representation representing the physical service environment being generated based on the sensor data, receiving information indicating at least one candidate node location in the spatial representation for a root access point (AP) of a wireless network, receiving information indicating at least one coverage area for the wireless network within the spatial representation, and outputting information indicating a recommended location of at least one mesh AP of the wireless network within the spatial representation, where the recommended location of the at least one mesh AP of the wireless network within the spatial representation is based at least in part on the at least one candidate node location of the root AP, the at least one coverage area for the wireless network, and physical properties of the physical service environment.

Another innovative aspect of the subject matter described in this disclosure can be implemented in a non-transitory processor-readable medium having stored thereon processor executable instructions. In some examples, the processor executable instructions are configured to cause a processing device in a computing device to perform operations including: receiving sensor data based on a scan of a physical service environment using at least one optical sensor associated with a device, a spatial representation representing the physical service environment being generated based on the sensor data, receiving information indicating at least one candidate node location in the spatial representation for a root access point (AP) of a wireless network, receiving information indicating at least one coverage area for the wireless network within the spatial representation, and outputting information indicating a recommended location of at least one mesh AP of the wireless network within the spatial representation, where the recommended location of the at least one mesh AP of the wireless network within the spatial representation is based at least in part on the at least one candidate node location of the root AP, the at least one coverage area for the wireless network, and physical properties of the physical service environment.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of an example system for providing a mesh AP placement recommendation for a wireless mesh network.

FIG. 3 shows a system flow diagram illustrating an example process for providing a mesh AP placement recommendation for a wireless mesh network.

FIG. 4 shows a pictorial diagram of an example physical service environment.

FIG. 5 shows a pictorial diagram of a spatial representation of an example physical service environment.

FIGS. 6A and 6B show pictorial diagrams for example AP placement combinations.

FIG. 7 shows a pictorial diagram of an AP placement recommendation for a wireless mesh network.

FIG. 8 shows a pictorial diagram of an AP placement recommendation for a wireless mesh network.

FIG. 9 shows a pictorial diagram of an updated AP placement recommendation 900 for a wireless mesh network.

FIG. 10 shows a flowchart illustrating an example process performable by or at a device that supports providing a mesh AP placement recommendation for a wireless mesh network.

FIG. 11 shows pictorial diagrams for models for generating a network performance score to provide a mesh AP placement recommendation for a wireless mesh network.

FIG. 12 shows a flowchart illustrating an example process performable by or at a device that supports providing a mesh AP placement recommendation for a wireless mesh network.

FIG. 13 shows a flowchart illustrating an example process performable by or at a device that supports determining a recommended location of at least one mesh AP.

FIG. 14 shows a flowchart illustrating an example process performable by or at a device that supports generating a network performance score for a plurality of AP placement combinations.

FIG. 15 shows a flowchart illustrating an example process performable by or at a device that supports providing a mesh AP placement recommendation for a wireless mesh network.

FIG. 16 shows a block diagram of an example recommendation device that supports providing a mesh AP placement recommendation for a wireless mesh network.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Mesh networks allow for a wireless network to be extended to cover a physical area larger than what is typically available to single node or access point (AP). For example, one node or AP provides a wireless connection over a finite area proximate to the AP. Wireless devices outside of the coverage area may not be able to successfully connect to the AP due to the distance or the physical obstacles between the device and radios at AP. In mesh networks, additional nodes are placed at a distance from each other where each additional node connects to at least one other node in the wireless mesh network via a mesh connection. In some examples, each additional node extends the coverage area of the wireless mesh network. While these wireless mesh networks provide extended coverage area, the physical locations of the mesh nodes can also present challenges which, in turn, reduce a capacity and function of the wireless mesh network. For example, mesh nodes may be arranged or placed in a physical service environment such that individual nodes and mesh connections perform poorly or provide degraded network connections. For example, larger distances between mesh nodes, physical obstructions, such as walls and furniture, and radio interference often lead to mesh connections with low reliability and limited bandwidth. Additionally, as mesh networks gain in popularity, consumers or other users may not have a technical knowledge or understanding of how to implement the setup of mesh networks to avoid network capacity and connection problems.

Various aspects relate generally to wireless mesh communication networks and more particularly to providing location recommendations for placing mesh radio nodes in a physical service environment. Some aspects more specifically relate to utilizing a spatial representation of the physical service environment to determine a recommend location for placement of the mesh radio nodes or mesh access points (APs) for a wireless network in the physical service environment. In some examples, a recommendation device with a mesh placement application receives sensor data from a scan of the physical service environment and generates the spatial representation using the sensor data. The recommendation device may also receive information indicating candidate node locations such as candidate node locations for a root AP and additional mesh APs. In some examples, the recommendation device also receives information indicating a coverage area for the wireless network within the spatial representation. In some examples, the recommendation device determines a recommended location for mesh APs within the spatial representation based on the candidate node location(s) of the root AP, the coverage area for the wireless network, and physical properties of the physical service environment. The recommendation device also outputs information, such as a placement diagram or map, indicating the recommended location of the mesh APs.

In some examples, the recommendation device selects placement parameters to generate various AP placement combinations where each combination includes candidate locations for a root AP and repeater node APs. The recommendation device also generates a network performance score for each combination and selects the AP placement combination with the high network performance score as the recommended location for the mesh APs. In some aspects, the recommendation device also refines or updates location recommendations using measured or observed network performance parameters once the mesh APs are positioned in a physical environment. In some examples, the recommendation device tests a network connection and updates a network performance score associated with a current location of the recommendation device during the test.

Particular aspects of the subject matter described in this disclosure can be implemented to realize one or more of the following potential advantages. In some examples, providing recommended locations of mesh APs in a spatial representation of a physical environment that is based on factors such as candidate locations for a root node, the coverage area for the wireless mesh network, and physical properties of the physical service environment, allows for a better performing mesh network than other placement schemes, such as manually placing mesh APs and testing resulting performance. In some examples using the spatial representation of the physical environment and the physical properties of the physical service environment to generate the candidate locations for the recommendation locations provides for recommended locations that provide high quality mesh connections in the network, while avoiding physical and other obstructions that may degrade network connections and network performance. In some examples, providing the recommend locations also simplifies updates of a mesh network layouts by recommending locations that provide expected network performance by providing updated recommended locations that will also increase mesh and network performance based on the simulated recommendations. For example, generating a spatial representation representing the physical locations and generating expected network traffic demand on the mesh APs, provides for recommend locations for the mesh APs based on expected and modeled performance. In some examples, using the spatial representation and expected network traffic demand helps avoid placing mesh APs in locations where network performance is not optimized. Additionally, measuring observed network performance for deployed mesh APs in recommended locations provides for updating recommendations at the recommendation device as well as providing information or training data to update or train a network simulator and other related learning models.

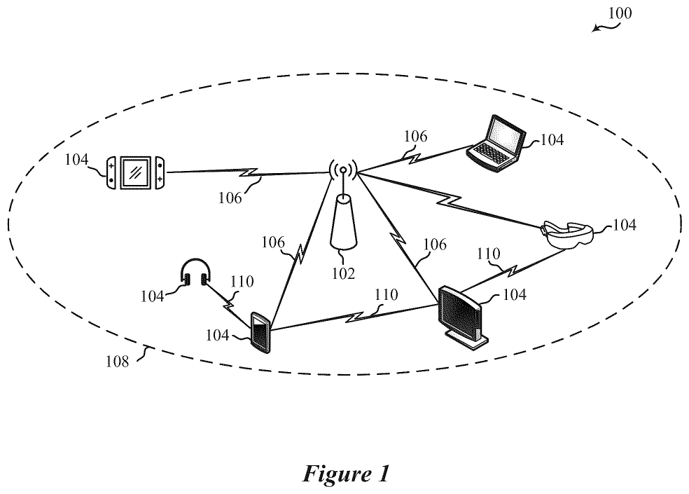

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as AP 102s and STA 104s) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

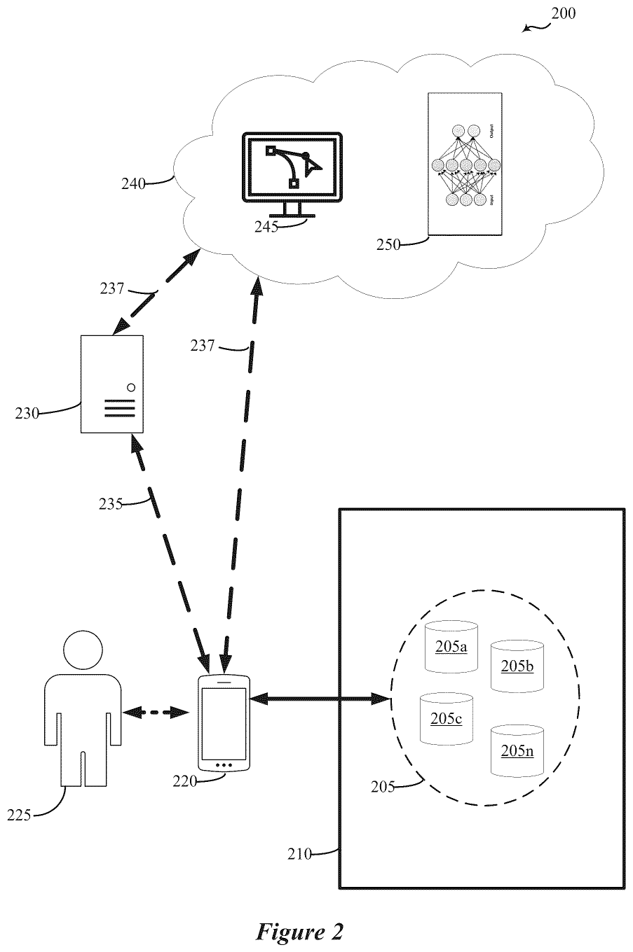

FIG. 2 shows a pictorial diagram of an example system 200 for providing a mesh AP placement recommendation for a wireless mesh network. In some aspects, the system 200 includes a wireless mesh network 205 in a physical service environment 210. In some examples, the wireless mesh network includes several mesh nodes, including mesh APs 205a-205n. In some implementations, to provide efficient wireless network coverage throughout the physical service environment 210, the mesh APs 205a-205n are placed at locations in the physical service environment 210 that increases the coverage area of the wireless mesh network 205. In some examples, the mesh APs 205a-205n also provides mesh network connections and client device connections that meet quality of service (QoS) requirements for the wireless mesh network 205.

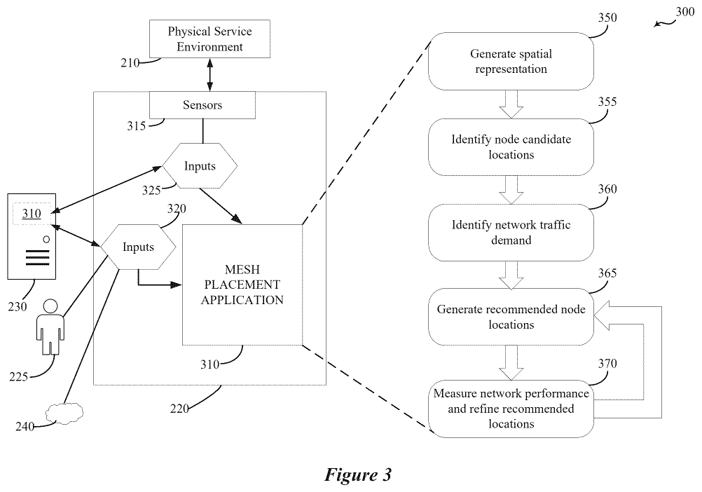

In some aspects, the system 200 includes a mesh recommendation device 220 which may interact with the wireless mesh network 205, the mesh APs 205a-205n, the physical service environment 210 and a user 225. In some examples, the mesh recommendation device 220 is a consumer device, such as a mobile phone, tablet device, computer or other similar device that includes user interfaces, network interfaces and other input/output components that enable the device to interact with the other components in the system 200. In some examples, the user 225 is a network administrator, consumer or other person that can move and place the mesh APs 205a-205n in the physical service environment 210 and enable the hardware infrastructure for the wireless mesh network 205. In some examples, the mesh recommendation device 220 includes a mesh placement application which generates and provides AP placement recommendations, including placement recommendations to the user 225 as described in more detail herein with reference to FIGS. 3-15. The mesh recommendation device 220 may also communicate with a server 230 via a communication link 235. In some examples, the server 230 provides inputs, settings and other data to the mesh recommendation device 220 to aid the mesh recommendation device 220 in providing placement recommendations. Additionally, the mesh recommendation device 220 and the server 230 may communicate with cloud-based applications 240 via the communication links 237. In some examples, the cloud-based applications 240 include a network simulator 245 and a ML training model 250 that interact with the mesh recommendation device 220 to generate and update mesh AP placement recommendations.

In some examples, as the mesh recommendation device 220 generates and refines AP placement recommendations and the intermediary components used to generate the placement recommendations, the device 220 may update and utilize the ML training model 250 and the network similar 245 to enable greater machine based network performance prediction.

In some examples, the mesh recommendation device 220 generates and provides the mesh AP placement recommendation for the wireless mesh network 205 in the physical service environment 210. In additional examples, parts or all of the mesh AP placement recommendation processes described herein may also be performed by the server 230 or the cloud-based applications 240, independently or in conjunction with the mesh recommendation device 220.

FIG. 3 shows a system flow diagram illustrating an example process 300 for providing a mesh AP placement recommendation for a wireless mesh network. In some implementations, the mesh recommendation device 220 includes a mesh placement application 310, which performs the process 300 to provide the mesh AP placement recommendations. In some examples, the mesh placement application 310 executes on the device 220, but in some examples, the mesh placement application 310 may also run or execute on a remote device using inputs received from the device 220. For example, the mesh placement application 310 may perform the process 300 on the server 230, as depicted in FIG. 3, the cloud-based applications 240 or other similar device/system. In some examples, the device 220 provides the inputs 325 and inputs 320 to the mesh placement application 310 running on the remote device, such as the server 230.

In some examples, the mesh placement application 310 uses various inputs and information, including inputs 320 and sensor inputs 325. In some examples, the inputs 320 may include any combination of inputs stored in a memory on the mesh recommendation device 220, received from the user 225, received from the server 230, and received from the cloud-based applications 240. For example, the inputs 320 may include traditional network simulations or components for a network simulation from the network simulator 245 and ML training models or inputs received from the ML training model 250. Additionally, the inputs 320 may include selections or information from the user 225 indicating a number of mesh APs available for placement, information regarding the various physical features of the physical service environment and other inputs requested from the mesh placement application 310. In some examples, the sensor inputs 325 include inputs received from sensors 315 associated with the mesh recommendation device 220. In some examples, the sensors 315 may include sensors integrated on the mesh recommendation device 220, including optical sensors such as a camera, Light Detection and Ranging (LIDAR) sensor, or other optical sensor, which may interact with the physical environment around the mesh recommendation device 220, including the physical service environment 210.

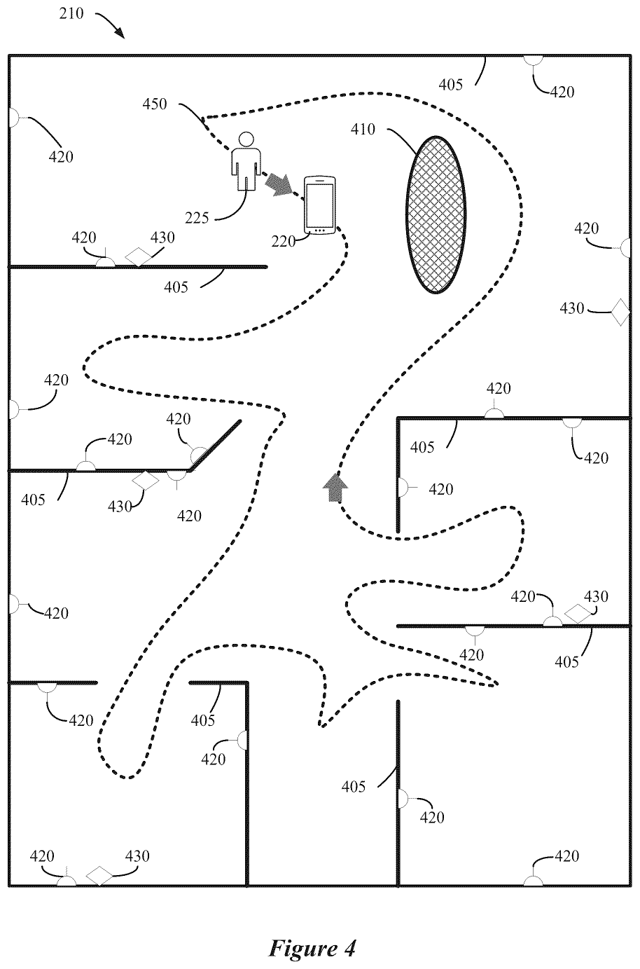

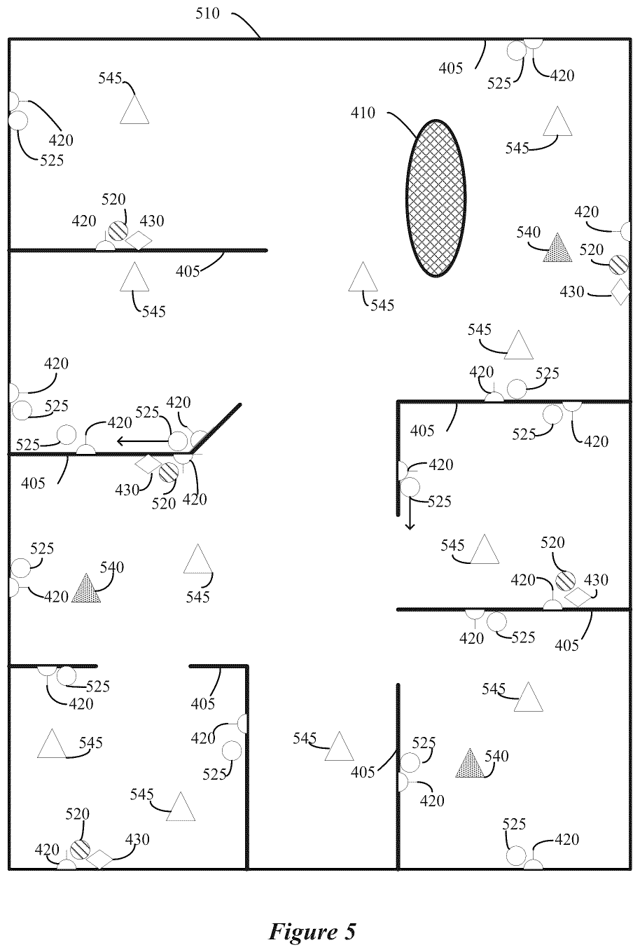

In some examples, the mesh placement application 310, using the inputs 320 and 325, generates and provides the AP placement recommendations through the process 300. In some examples, in block 350, the mesh placement application 310 generates a spatial representation for the physical service environment 210 as described in more detail with reference to FIGS. 4 and 5.

In some examples, in block 355, the mesh placement application 310 identifies node candidate locations. In some implementations, node locations may include user inputs provided by the user 225 that include candidate locations to connect to a wide area network (WAN), such as a wired modem, direct ethernet connection or other network connection. The user 225 may also provide inputs indicating candidate power source locations, such as wall plugs or power strips, that can provide power to mesh APs in the wireless mesh network 205. In some examples, the sensor inputs 325 may also be used to identify power source locations and WAN connection locations using image identification and learning techniques. Further example node candidate locations are described in more detail herein with reference to FIG. 5.

In some examples, in block 360, the mesh placement application 310 identifies network traffic demand. In some examples, the user 225 provides inputs identifying key locations in the physical service environment 210 to cover and also identifies corresponding network traffic demands for the clients in the key locations. In some examples, the application 310 also uses object recognition with context to identify potential areas of high network traffic within the physical service environment 210. In some examples, identifying key traffic locations is described in more detail herein with reference to FIG. 5.

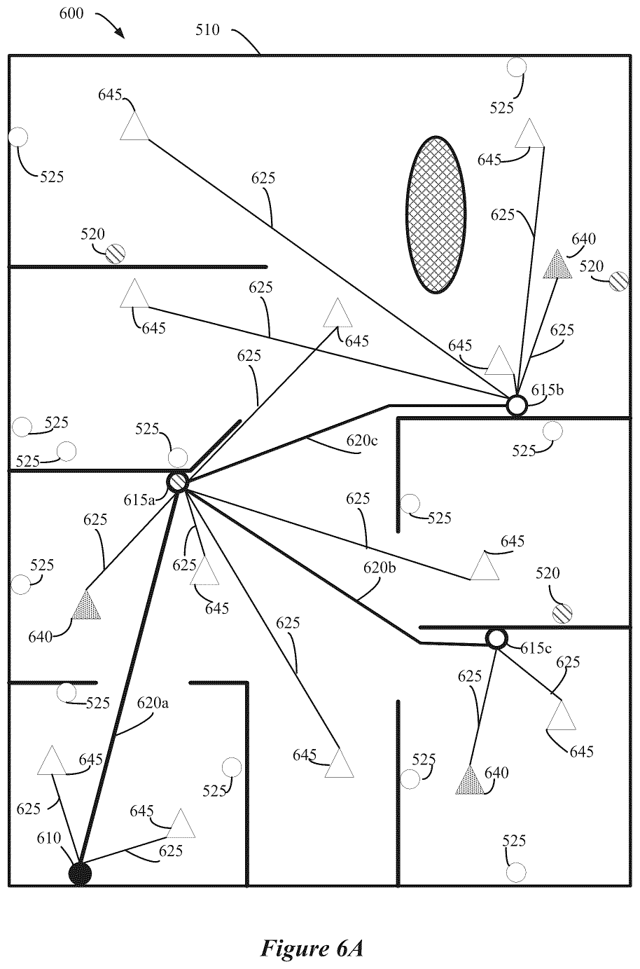

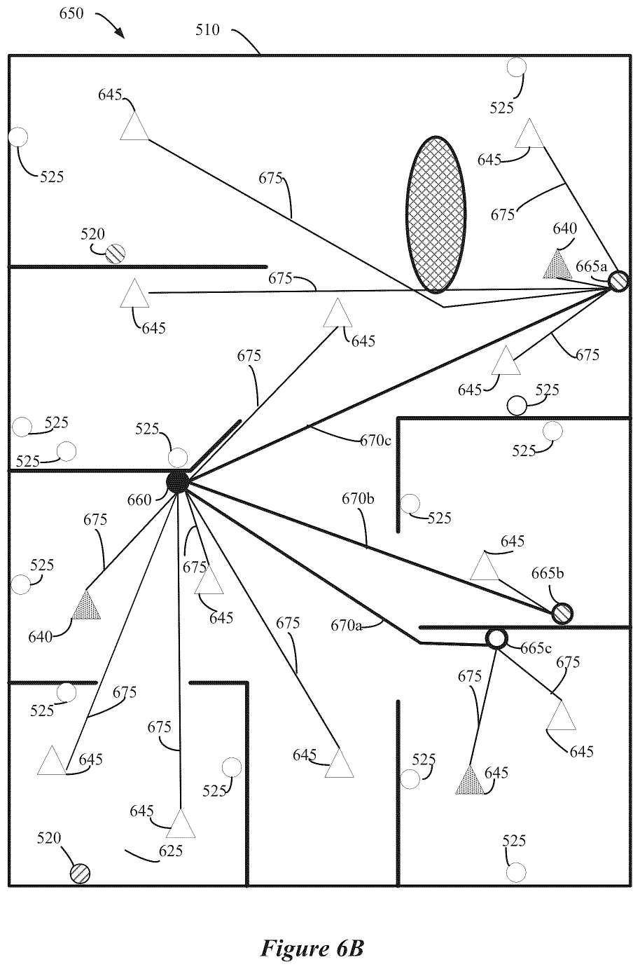

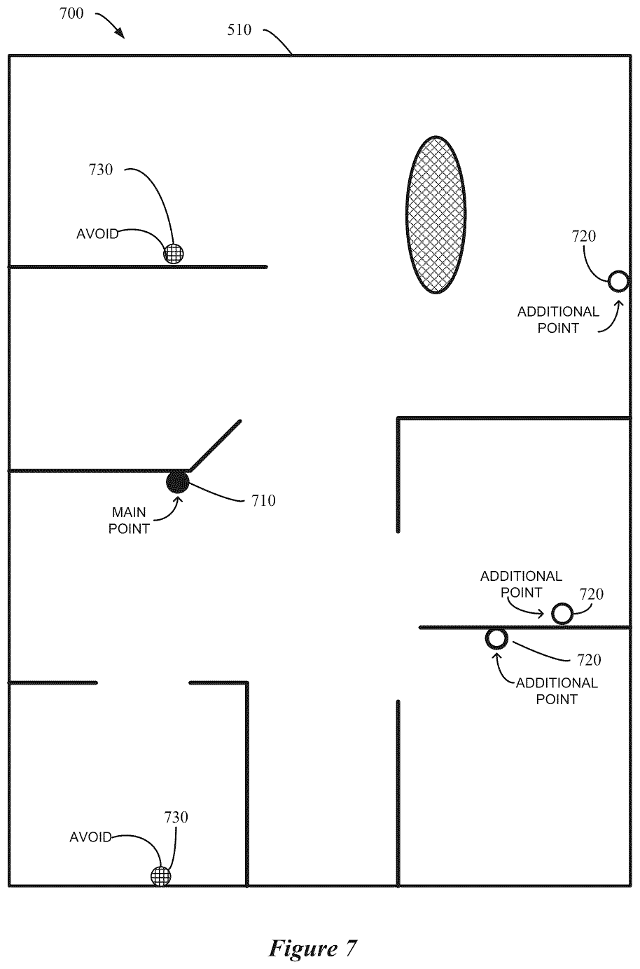

In some examples, in block 365, the mesh placement application 310 generates recommended node locations. For example, the mesh placement application 310 may determine a recommended location of at least one mesh AP of the nodes 205a-n within the spatial representation based on a candidate node location of the root AP, the at least one coverage area for the wireless network, and physical properties of the physical service environment. In some examples, a number of mesh APs available for placement in the physical service environment may be provided by the user 225 or determined by the mesh placement application 310. In some examples, the recommended location of at least one mesh AP is based on the number of mesh APs available. In some examples, the mesh placement application 310 may also determine a number of mesh APs to recommend be placed in the physical service environment to achieve a network performance. In some examples, the mesh placement application 310 also provides the recommended node locations to a user. For example, the mesh placement application 310 may output information indicating the recommended location of the at least one mesh AP within the spatial representation. Determining a recommended location and example node recommended location outputs are described in more detail herein with reference to FIGS. 6A-7.

In some examples, in block 370, the mesh placement application 310 measures network performance and refines the recommended locations. For example, the mesh placement application 310 may receive an indication that a mesh AP is positioned in a recommended physical location in the physical service environment 210. Upon determining the mesh AP is in place the application 310 may measure at least one network performance parameter of the wireless network and update the recommended location of one more mesh APs within the spatial representation based on the network performance parameters.

FIG. 4 shows a pictorial diagram of an example physical service environment 210. In some examples, the physical service environment 210 is an indoor environment and includes walls 405. In another example, the physical service environment 210 may be an outdoor environment or a combination of indoor and outdoor spaces. In some examples, a wireless mesh network is desired to cover all of the physical service environment 210. For example, the physical service environment 210 may be a home, office, commercial establishment or other similar physical service environment where wireless network connectivity is desired. For example, the user 225 may desire to connect to a Wi-Fi network, such as the wireless mesh network 205 in every room in their home or office.

In some examples, the physical service environment 210 includes physical obstacles or objects, such as physical object 410 which may block or obstruction wireless signals in the physical service environment 210. For example, the physical object 410 may be a large object such as furniture, a vehicle or other signal impermeable object that blocks or interferes with wireless signals, including signals in the wireless mesh network 205. In some examples, the physical properties, including the physical object 410, the walls 405 and other physical properties of the physical service environment 210 may limit the signal or communication paths between wireless communication devices in the physical service environment 210. In some examples, these physical properties complicate the placement of mesh APs in the environment. For example, the user 225 may place a mesh AP in a location in the physical service environment 210 that results in negative network outcomes. For example, some mesh AP placements may result in some nodes being overloaded with client connections and network traffic, thus resulting in traffic congestion on mesh connection or mesh backhauls between mesh APs.

In some implementations, the user 225 utilizes the mesh recommendation device 220 to generate a spatial representation that is utilized in the generation and output of mesh AP placement recommendations. In some examples, the user 225 may move the mesh recommendation device 220 throughout the environment, such as along scan path 450 to capture optical or other scan information representing the physical service environment 210. The mesh recommendation device 220 may also identify various additional physical properties in the physical service environment 210, such as power source locations 420 and WAN connection locations 430. Additionally, the user 225 may also provide inputs to the mesh recommendation device 220 to add the power source locations 420 and WAN connection locations 430 to a spatial representation. In some examples, during a scan process of the physical service environment 210, the mesh recommendation device 220 may provide the user 225 visual or audible instructions through a user interface to ensure adequate optical information is collected to generate a spatial representation of the environment as described in more detail in FIG. 5.

FIG. 5 shows a pictorial diagram of a spatial representation 510 of an example physical service environment 210. In some examples, a recommendation device, such as the mesh recommendation device 220 generates the spatial representation 510 sensor data based on a scan such as the scan performed along the scan path 450 discussed in relation to FIG. 4. In some examples, the mesh recommendation device 220 includes the physical properties, such as wall and physical objects in the spatial representation 510. In some examples, the spatial representation 510 includes the power source locations 420 and WAN connection locations 430 as detected by the mesh recommendation device 220 or provided by the user 225. The mesh recommendation device 220 may also generate root node candidate locations 520 and repeater node candidate locations 525 using the power source locations 420 and WAN connection locations 430. In some examples, the root node candidate locations 520 are associated with locations in the spatial representation 510 that are proximate to both a power source location 420 and a WAN connection location 430. In some examples, either a root AP mesh node or repeater AP mesh node may be located at any of the root node candidate locations 520. In some examples, the repeater node candidate locations 525 are associated with locations in the spatial representation 510 that are proximate to just a power source location 420. In both examples, the root node candidate locations 520 and repeater node candidate locations 525 may be adjusted with a given tolerance in the spatial representation 510. For example, a node may be extended in several directions from the candidate location depicted in the spatial representation 510 using a power cord and/or network extension cable.

In some implementations, the spatial representation 510 includes candidate client anchor locations such as high traffic anchor locations 540 and anchor locations 545. In some examples, the mesh recommendation device 220 receives information indicating expected areas of high wireless network demand from the user 225. For example, the user 225 may indicate that a room or area in the physical service environment 210 is expected to host more network traffic than other areas. The mesh recommendation device 220 may also detect expected areas of high demand using optical sensor data. For example, the mesh recommendation device 220 may identify stream devices or other network devices that may send and receive large amounts of network traffic in the wireless network. In some examples, the candidate client anchor locations are added to the spatial representation 510 based on the expected areas of high wireless network demand. Upon generating the spatial representation, the mesh recommendation device 220 may generate AP placement combinations and generate scores for the AP placement combinations as described in more detail in FIGS. 6A and 6B.

FIGS. 6A and 6B show pictorial diagrams of example AP placement combinations. FIG. 6A shows an AP placement combination 600 and FIG. 6B shows an AP placement combination 650. In some examples, the mesh recommendation device 220 generates the AP placement combinations 600 and 650 by selecting a root node AP location, using the candidate root node locations, such as repeater node candidate locations 525, and selecting repeater node AP locations using the candidate power source locations 420 and candidate client anchor locations, high traffic anchor locations 540 and anchor locations 545.

In some examples, the AP placement combinations 600 includes a root node 610 located at a root node candidate location 520 and mesh nodes 615a-615c. In some examples, the AP placement combination 600 includes client connections 625 to represent client network connections between virtual client devices 640 and 645 situated at the various candidate client anchor locations and the various mesh nodes. The AP placement combination 600 also includes mesh connections 620a-c between the mesh nodes. The AP placement combinations 650 includes a root node 660 and mesh nodes 665a-665c. The AP placement combination 650 also includes client connections 675 to represent client network connections between the virtual client devices 640 and 640 and the various mesh nodes and mesh connections 670a-670c. In some examples, the mesh recommendation device 220 uses the AP placement combinations 600 and 650 along with additional combinations to select the AP placement combination with a highest network performance score as the AP placement configuration for the physical service environment. In some examples, the selected AP placement configuration is provided to a user as the recommended location as described in more detail in FIG. 7.

FIG. 7 shows a pictorial diagram of an AP placement recommendation 700 for a wireless mesh network. In some examples, the recommendation 700 includes recommended root location 710 and repeater node locations 720. In some locations the recommendation 700 also includes avoid locations 730, which indicate areas that mesh AP nodes should not be placed to avoid network connection problems in the wireless mesh network 205. In some examples, a recommendation device, such as the mesh recommendation device 220, determines a recommended location of the mesh APs within the spatial representation 510 based on the candidate node locations of the mesh APs, the at least one coverage area for the wireless network, and physical properties of the physical service environment. In some examples, the output information indicating the recommended location of the mesh APs within the spatial representation includes the recommendation 700 as a map or layout of the spatial representation 510 with the recommended locations marked on the map.

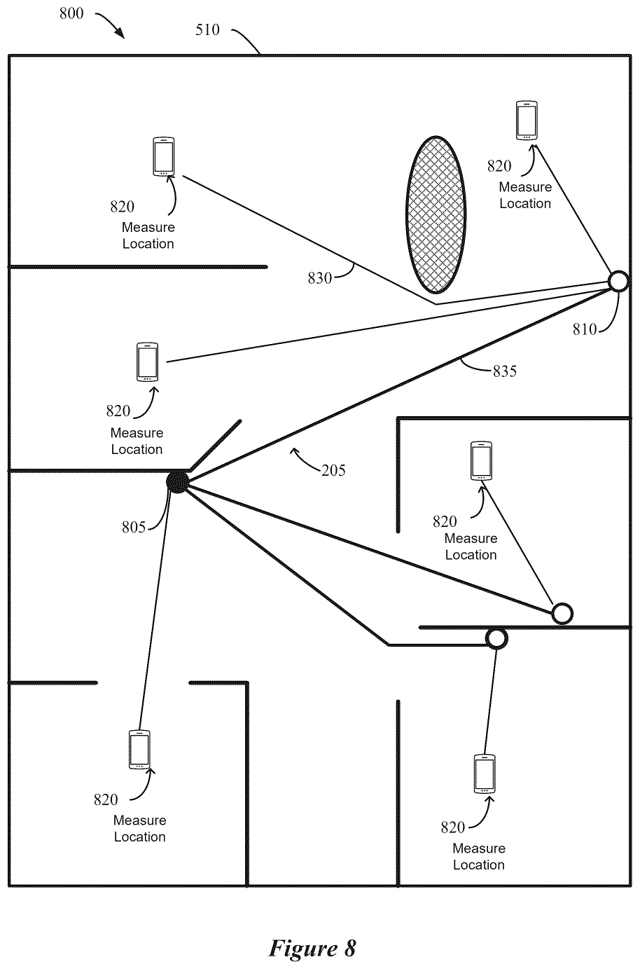

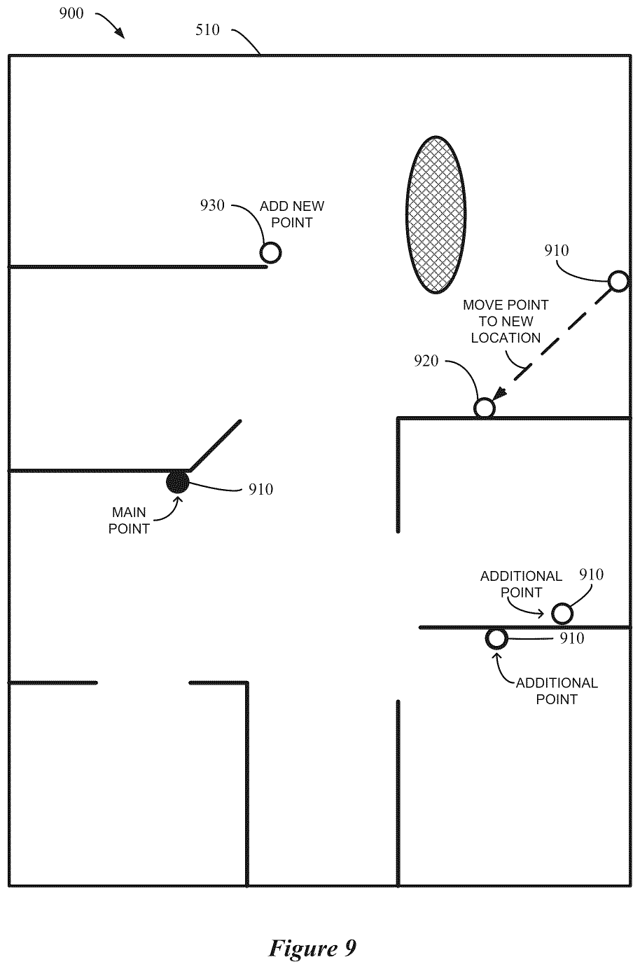

FIG. 8 shows a pictorial diagram of an AP placement recommendation 800 for a wireless mesh network. In some examples, the AP placement recommendation 800 is a recommendation that provides additional locations in the spatial representation 510 to verify or measure the network performance parameters and adjust the AP placement recommendation. In some examples, the recommendation 800 includes recommended root location 805 and repeater node locations 810. In some examples, the recommendation 800 also includes suggested measure locations 820, which indicate areas or locations that the mesh recommendation device 220, or other measuring device, may locate to test the wireless mesh network 205. For example, a device may measure at least one observed network performance parameter of the wireless mesh network 205 associated with active mesh APs including over the client connection 830 and mesh connection 835. In some examples, the observed network performance is used to update the AP placement recommendation as described in more detail in FIG. 9.

FIG. 9 shows a pictorial diagram of an updated AP placement recommendation 900 for a wireless mesh network. In some examples, the mesh recommendation device 220 may determine from the observed network performance score, that a different combination of AP locations should be used in the wireless mesh network 205. In some examples, the mesh recommendation device 220 selects a new AP combination for the wireless mesh network 205 and indicates any changes to mesh placement in the recommendation 900. For example the recommendation 900 includes instruction to move a repeater node 910 to the new location 920 or add a new mesh AP 930 to the mesh network 205.

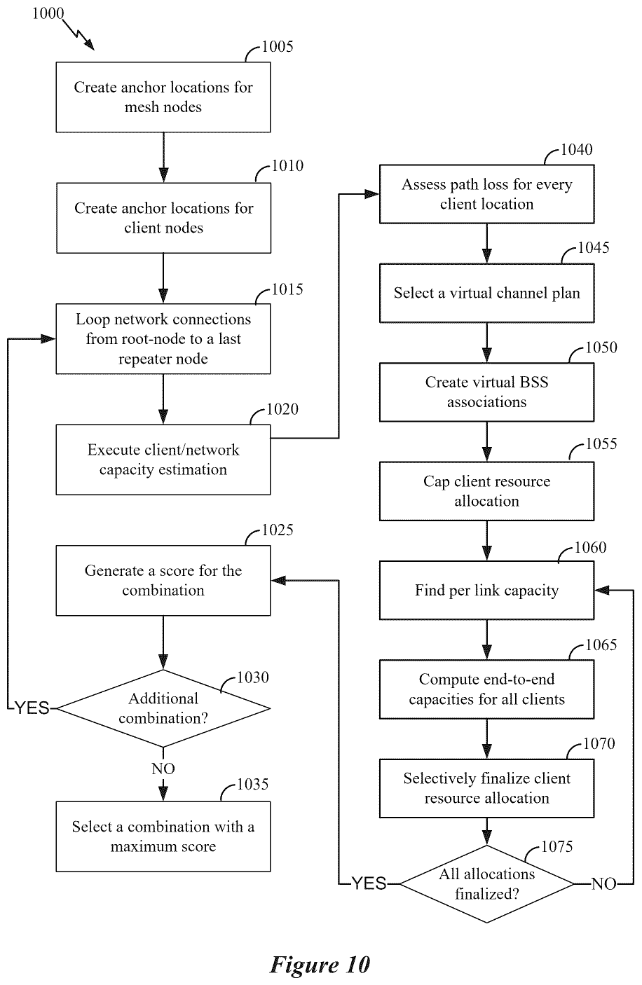

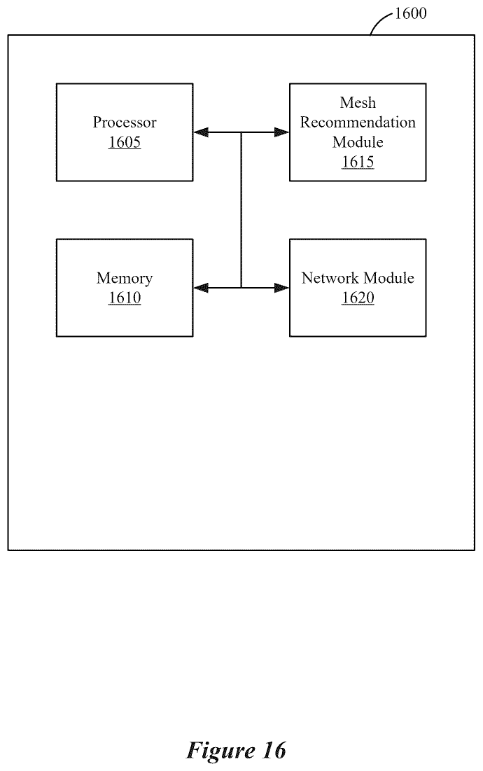

FIG. 10 shows a flowchart illustrating an example process 1000 performable by or at a device that supports providing a mesh AP placement recommendation for a wireless mesh network. The operations of the process 1000 may be implemented by a mesh recommendation device or its components as described herein. For example, the process 1000 may be performed by a wireless communication device, such as the recommendation device 1600 described with reference to FIG. 16, operating as or within a mesh recommendation device. In some examples, the process 1000 may be performed by a mesh recommendation device such as one of the STAs 104 described with reference to FIG. 1 or the mesh recommendation device 220 described with reference to FIGS. 2 and 3.

In some examples, in block 1005, the mesh recommendation device 220 creates or generates anchor locations for mesh AP nodes. For example, as shown in FIG. 5 the mesh recommendation device 220 generates the candidate locations 520 for locations in spatial representation 510 that are associated with a WAN connection, such as cabled ports, ethernet access points or other wired network connection. The mesh recommendation device 220 also generates the repeater node candidate locations 525 in locations associated with a power source or power outlets, but not a WAN connection point.

In some examples, in block 1010, the mesh recommendation device 220 creates anchor locations for client nodes. In some implementations, the mesh recommendation device 220 may create or generate virtual clients in all corners or areas of the spatial representation 510. For example, as shown in FIG. 5, each area separated by a wall 405 includes at least one virtual client device 640 or 645 within the area. In some examples, the placement of the virtual clients and locations may be selected or changed by the user 225. Additionally, the mesh recommendation device 220 may also update the location of various virtual clients in the spatial representation 510 based on the geometry of the physical service environment 210 and physical properties of the environment.

In some examples, in block 1015, the mesh recommendation device 220 loops or creates network connections from a root-node to a last repeater node. For example, the mesh recommendation device 220 may select a root node location and then proceed through combinations of the root node to each candidate node location for additional mesh APs. In some examples, combinations of mesh AP nodes may be limited, reduced or skipped using heuristics or placement parameter preferences at the mesh recommendation device 220. These placement parameter preferences may include settings to prioritize locations that increase Received Signal Strength Indicator (RSSI) of virtual clients to a specified threshold. The placement parameter preferences may also include prioritizing candidate locations that increase a minimum client capacity for the wireless mesh network 205 or exclude AP placement combinations that do not increase the minimum client capacity. In some examples, the placement parameter preferences also may include excluding locations that would make create a bottleneck on a backhaul mesh connection between mesh APs.

In some examples, the placement parameter preferences may also include settings to associate client locations to a nearest mesh node in path loss simulation and limit search depth and width for every node in the AP placement search tree. Additional placement parameter preferences may also include settings to not consider client-specific traffic demands, to not consider tradeoff between aggregate capacity and fairness or not consider location specific client population. In some examples, placement parameter preferences may also include settings to not consider in-network OBSS conditions, to not consider E2E capacity between clients and other network devices and to not consider different fronthaul channels. The placement parameter preferences may include any combination of the above settings based on user preferences or network settings.

In some examples, in block 1020, the mesh recommendation device 220 executes a client and network capacity estimation to generate estimated network factors for calculating a network performance score for the AP placement combination. For example, in block 1020, the mesh recommendation device for each non-excluded combination, the mesh recommendation device 220 may generate a capacity or network performance estimation for the AP placement combination of the nodes at the selected root node AP location and repeater node AP locations as described in relation to blocks 1040-1075

In some examples, in block 1040, the mesh recommendation device 220 assesses a path loss for every client location. For example, the mesh recommendation device 220 uses the representation 510 including the physical properties of the representation to generate estimated path loss for the connections 625 in the combination 600.

In some examples, in block 1045, the mesh recommendation device 220 selects a virtual channel plan. For example, the mesh recommendation device 220 may select a default channel plan for the wireless mesh network 205, including the connection 625 and 620a-620c shown in FIG. 6A. In some examples, the mesh recommendation device 220 may also select a channel plan based on inputs from the user 225, the server 230, and the cloud-based applications 240.

In some examples, in block 1050, the mesh recommendation device 220 creates virtual BSS associations for the wireless devices in the combination. For example, the mesh recommendation device 220 may associate client locations, including virtual client devices 640 and 645 to a nearest mesh node in the AP placement combination 600 based on the path loss for the client device.

In some examples, in block 1055, the mesh recommendation device 220 caps client resource allocation for the purposes of modeling the AP placement combination. For example, each of the virtual client devices 640 and 645 may be assigned an expected amount of resource usages based on the type of modeled device. For example, a video streaming device may be capped at a higher resource allocation than a low transmitting IoT device in the network.

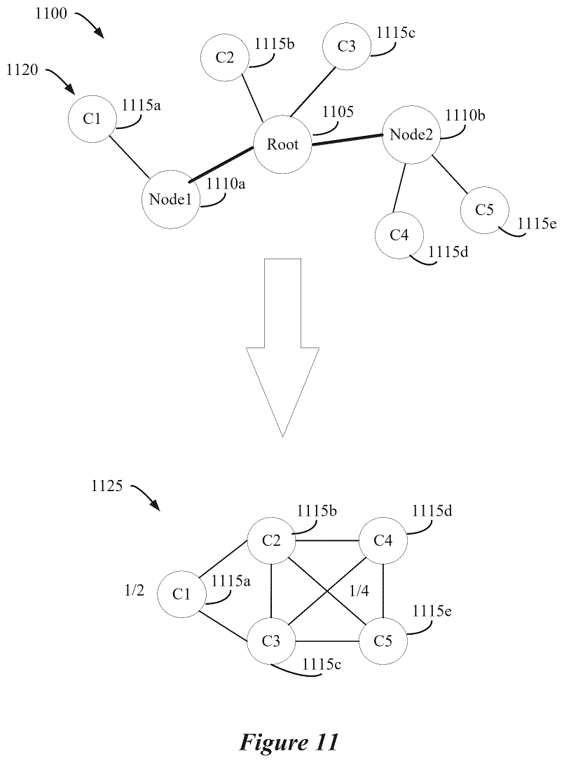

In some examples, in block 1060, the mesh recommendation device 220 finds or models a per link capacity. In some examples, the mesh recommendation device 220 may generate a nodal graph model representing the AP placement combination and convert the nodal graph model to a contention graph model as shown in FIG. 11.

FIG. 11 shows pictorial diagrams for models 1100 for generating a network performance score to provide a mesh AP placement recommendation for a wireless mesh network. In some examples, the models 1100 include a nodal graph model 1120 which includes a representation of a root node 1105, repeater node 1110a, a repeater node 1110b and client nodes 1115a-1115e. In some examples, the mesh recommendation device 220 transforms or converts the model 1120 to a contention graph model 1125 to enable calculation of a maximum and minimum link capacity for the modeled mesh nodes. In some examples, the mesh recommendation device 220 calculates a max-min link capacity for every flow contention graph across all channels in the AP placement combination.

Returning to FIG. 10, in some examples, in block 1065, the mesh recommendation device 220 computes end-to-end (E2E) capacities for all clients across the AP placement combination. For example, the mesh recommendation device 220 may compute network wise proportional fair E2E capacities for each modeled client using a bottom up to root-AP calculation approach.

In some examples, in block 1070, the mesh recommendation device 220 selectively finalizes client resource allocation. For example, the mesh recommendation device 220 may set E2E capacities to final for the clients when the modeled traffic demand can be served in the current modeled capacity.

In some examples, in block 1075, the mesh recommendation device determines whether all client resources are allocated. In some examples, the process 1000 proceeds back to block 1060 to repeat the calculation for clients whose E2E capacities are not finalized for the AP placement combination. Upon determining that all resource allocations for the virtual clients have been finalized for the AP placement combination, the process 1000 proceeds to block 1025.

In some examples, in block 1025, the mesh recommendation device 220 generates a network performance score for the AP placement combination based on the estimated client capacities and the overall network capacity estimated in blocks 1040-1075. In some examples, the network performance score may also use additional or alternate network performance measures to generate the performance of the modeled network for the AP placement combination.

In some examples, the network performance score is generated to represent the overall network performance of the AP placement combination while adjusting the network performance based on the various properties of the mesh network of the AP placement combination. For example, the network performance score for an AP placement combination may be lower if a number of client devices able to connect to the network is below a threshold or if the individual network connections performance at the client devices is below a QoS of the simulated client devices. For example, a network performance score for a first AP placement combination may be lower than a score for a second an AP placement combination if the client devices experience slower or inconsistent network connections or if a lower number of client devices are able to connect to the first combination compared to the second combination.

In some examples, the mesh recommendation device 220 may generate using a log function to generate a score to balance between a client capacity for each client simulated in the network and corresponding network capacity. For example, using Rᵢ as a client capacity estimate, the score may be generated using Equations 1 and 2 below, where Equation 1 provides a score value and Equation 2 providers for lower scores when client capacity is missing in the modeled network for the AP placement combination.

$$\sum log {f}_{i} ( {R}_{i} ) \qquad Equation 1$$

$${f}_{i} ( {R}_{i} ) = \{ \begin{matrix}{R}_{i} , & {R}_{i} \geq {λ}_{i} \\ {e}^{{R}_{i}} ( \frac{1 + {λ}_{i}}{{e}^{{λ}_{i}}} ) - 1 , & {R}_{i} < {λ}_{i}\end{matrix} \qquad Equation 2$$

In some examples, in block 1030, the mesh recommendation device determines whether additional combinations are possible for a given model run. For example, the device determines whether additional AP placement combinations are possible using the non-excluded anchor locations for mesh nodes generated/created in block 1005. In some examples, in block 1035, the mesh recommendation device 220 selects an AP placement combination with a maximum score as an AP placement recommendation.

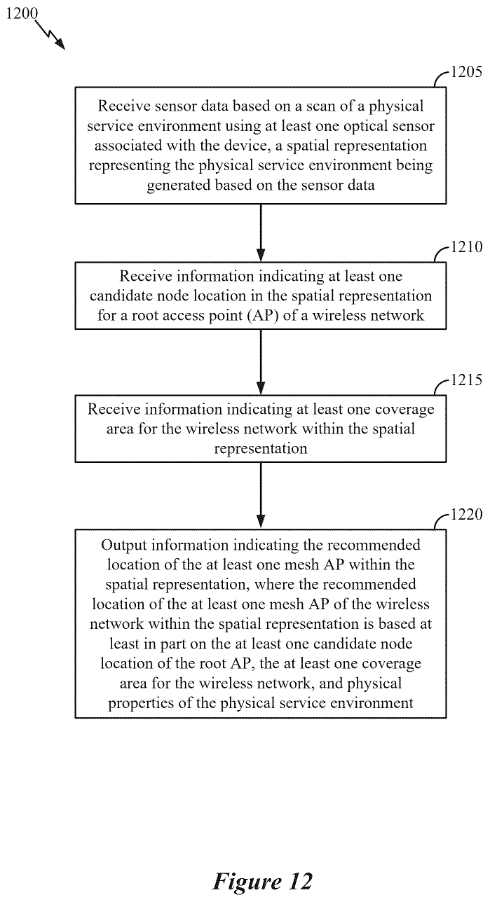

FIG. 12 shows a flowchart illustrating an example process 1200 performable by or at a device that supports providing a mesh AP placement recommendation for a wireless mesh network. The operations of the process 1200 may be implemented by a mesh recommendation device or its components as described herein. For example, the process 1200 may be performed by a wireless communication device, such as the recommendation device 1600 described with reference to FIG. 16, operating as or within a mesh recommendation device. In some examples, the process 1200 may be performed by a mesh recommendation device such as one of the STAs 104 described with reference to FIG. 1 or the mesh recommendation device 220 described with reference to FIGS. 2 and 3.

In some examples, in block 1205, the mesh recommendation device receives sensor data based on a scan of a physical service environment using at least one optical sensor associated with the device. In some examples, a spatial representation representing the physical service environment is generated based on the sensor data. For example, as described with reference to FIGS. 3-5, the mesh device may receive sensor inputs 325 captured during a scan of the physical service environment 210 to generate a spatial representation 510 of the physical service environment 210.

In some examples, the sensor inputs 325 are received from sensors 315 which include at least an optical sensor used to scan the physical service environment 210 and to collect sensor data representing the physical service environment 210. In some examples, the optical sensor is an image sensor, such as a mobile phone camera. In some additional examples, the optical sensor includes a LIDAR sensor used to scan the physical service environment 210 and detect various physical properties, objects and obstructions associated with the physical environment.

In some examples, in block 1210, the mesh recommendation device receives information indicating at least one candidate node location in the spatial representation for a root access point (AP) of a wireless network. In some examples, the mesh recommendation device also generates or adds other components or representations to the spatial representation 510. For example, the spatial representation 510 may also include candidate locations to connect WAN (WAN connection locations 430), candidate power source locations (power source locations 420) and other physical obstacles detected in the physical spatial representation 510. In some examples, the mesh recommendation device 220 may add the additional elements or representations using image detection process on the sensor inputs 325 as well as using user inputs from the user 225.

In some examples, in block 1215, the mesh recommendation device receives information indicating at least one coverage area for the wireless network within the spatial representation. In some examples, the mesh recommendation device 220 receives information indicating expected areas of high wireless network demand. The expected areas of high demand may include both information provided by the user 225 or other entity as well as information derived from the sensor inputs 325. For example, the user 225 may indicate that an area in the physical service environment 210 is a high traffic or high device area. In another example, the mesh recommendation device 220 may detect high network traffic devices or other indications that represent that a given area is a high traffic area in the physical service environment 210. In some examples, the mesh recommendation device 220 adds candidate client anchor locations to the spatial representation 510 based on the expected areas of high wireless network demand. For example, the mesh recommendation device 220 adds the candidate client anchor locations 540 and 545 to the spatial representation 510 to represent high traffic areas, along with other areas expecting wireless network connection. In some examples, the mesh recommendation device 220 selects the recommended location of the at least one mesh AP based at least in part on the expected areas of high wireless network demand as described herein.

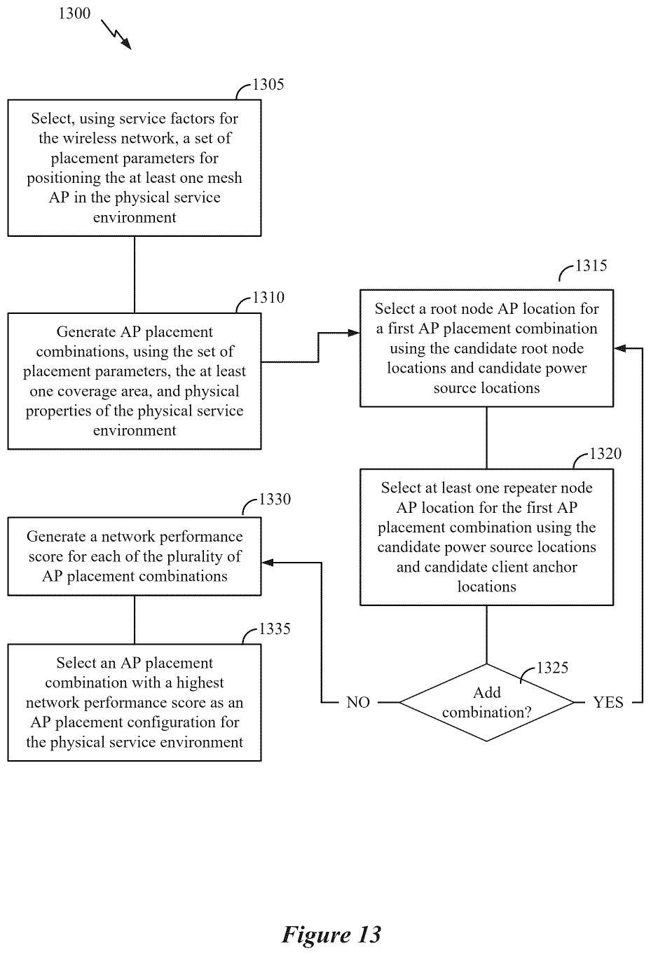

In some examples, in block 1220, the mesh recommendation device outputs information indicating the recommended location of the at least one mesh AP within the spatial representation. In some examples, the mesh recommendation device may determine a recommended location of at least one mesh AP of the wireless network within the spatial representation based at least in part on the at least one candidate node location of the root AP, the at least one coverage area for the wireless network, and physical properties of the physical service environment. In some examples, the mesh recommendation device 220 generates a variety of AP placement combinations and scores the AP placement combination to determine which combination to select as the recommend location as described in more detail with reference to the process in FIG. 13.

In some examples, the mesh recommendation device 220 may select the AP placement combination 650 shown in FIG. 6B as the recommended location for the next AP and output the AP placement recommendation 700 as a visual output to the user 225. In some examples, the AP placement recommendation 700 includes a suggested placement for all available mesh APs, including root APs and repeater APs. In some examples, the AP placement recommendation 700 may also include a suggested placement for a next AP to be placed, including an indication on a location for a next repeater node. The AP placement recommendation 700 may also include locations to avoid placing mesh APs due to negative network effects on the wireless mesh network 205.

FIG. 13 shows a flowchart illustrating an example process 1300 performable by or at a device that supports determining a recommended location of at least one mesh AP. In some examples, the mesh recommendation device performs the process 1300 as part of determining a recommended location of at least one mesh AP of the wireless network as discussed in relation to block 365 described with reference to FIG. 3 and block 1220 described with reference to FIG. 12. The operations of the process 1300 may be implemented by a mesh recommendation device or its components as described herein. For example, the process 1300 may be performed by a wireless communication device, such as the recommendation device 1600 described with reference to FIG. 16, operating as or within a mesh recommendation device. In some examples, the process 1300 may be performed by a mesh recommendation device such as one of the STAs 104 described with reference to FIG. 1 or the mesh recommendation device 220 described with reference to FIGS. 2 and 3.

In some examples, in block 1305, the mesh recommendation device selects, using service factors for the wireless network, a set of placement parameters for positioning the at least one mesh AP in the physical service environment. In some examples, the service factors may include QoS requirements or other network size/capacity factors indicated by the user or stored in on the mesh recommendation device 220. In some examples, the mesh recommendation device 220 may receive a selection of a placement parameter preference for the wireless network. For example, the set of placement parameters may also be received directly from the user 225, the network simulator 245 or other network entity. In some examples, the placement parameters may include heuristics or other selection preferences that instruct the mesh recommendation device 220 to select mesh AP candidate locations that increase a minimum throughput for an expected overall network traffic demand for the wireless network and select mesh AP candidate locations that increase a capacity of client devices connected to the wireless network. The placement parameters may also include additional parameters such as select mesh AP candidate locations that satisfy an expected network traffic demand for the one or more client devices connected to the wireless network, select mesh AP candidate locations that utilize a number of mesh APs for placement in the physical service environment, and exclude mesh AP candidate locations that create constrained network traffic pathways.

For example, the number of mesh APs available for placement in the physical service environment may be provided by a user or determined by the mesh placement application and the parameters indicate that each of the number of available mesh APs should be placed in the environment. In some examples, the recommended location of at least one mesh AP is based on the number of mesh APs available. In some examples, the mesh recommendation device may also determine a number of mesh APs to recommend be placed in the physical service environment to achieve a network performance. For example, if a given number of mesh AP nodes may provide a desired network performance, the mesh network device may include the number of APs needed to meet the network performance based on the AP placement combinations.

In some examples, in block 1310, the mesh recommendation device generates, using the set of placement parameters, the at least one coverage area, and physical properties of the physical service environment, a plurality of AP placement combinations, where each AP placement combination includes a location in the spatial representation for the root AP and the at least one mesh AP. In some examples, the AP placement combinations may be used by the mesh recommendation device to generate or determine a recommended location of at least one mesh AP of the wireless network as discussed in relation to block 1220 described with reference to FIG. 12. In some examples, the generation of AP placement combinations is described in more detail in relation to blocks 1315-1325 herein.

In some examples, in block 1315, the mesh recommendation device selects a root node AP location for a first AP placement combination of the plurality of AP placement combinations using the candidate root node locations and candidate power source locations. For example, in the AP placement combination 600 depicted in FIG. 6A, the mesh recommendation device 220 selects one of the locations 520 of the spatial representation 510 for the root node 610.

In some examples, in block 1320, the mesh recommendation device selects at least one repeater node AP location for the first AP placement combination using the candidate power source locations and candidate client anchor locations. For example, in the AP placement combination 600 depicted in FIG. 6A, the mesh recommendation device 220 selects three of the repeater node candidate locations 525 of the spatial representation 510 for the mesh AP locations 615a-615c.

In some examples, in block 1325, the mesh recommendation device determines whether to generate additional AP placement combinations. In some examples, such as when additional combinations are available, the process 1300 returns to block 1315 to generate and additional AP placement combination, such as the AP placement combination 600 depicted in FIG. 6B. In some examples, at block 1325, the mesh recommendation device 220 using the selection parameters and available candidate node locations determines that all feasible or available combinations have been generated for the spatial representation 510 and the process 1300 proceeds to block 1330.

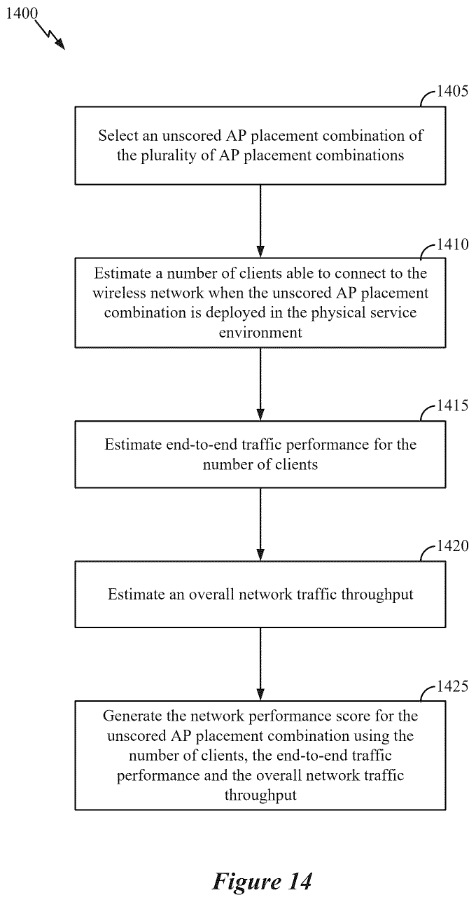

In some examples, in block 1330, the mesh recommendation device generates a network performance score for each of the plurality of AP placement combinations. For example, the mesh recommendation device 220 generates a performance score for the AP placement combination 600 and the AP placement combination 650 (among others) using network performance factors and calculations which are described in further detail in relation to the process of FIG. 14.

In some examples, in block 1335, the mesh recommendation device selects an AP placement combination with a highest network performance score as an AP placement configuration for the physical service environment. In some examples, the AP placement combination 600 has a limited client capacity and limited overall network throughput capacity due to a congested backhaul link on the mesh connection 620a. These factors result in a lower network performance score compared to the AP placement combination 650, which avoids the congested backhaul by distributing the mesh nodes and associated client sin a more efficient manner. In this example, the mesh recommendation device 220 selects the combination 650 as the AP placement configuration for the wireless mesh network 205 in the physical service environment 210. In some examples, the selected AP placement combination is outputted as part of the information indicating the recommended location of the at least one mesh AP within the spatial representation as discussed in relation to block 1220 described with reference to FIG. 12.

FIG. 14 shows a flowchart illustrating an example process 1400 performable by or at a device that supports generating a network performance score for a plurality of AP placement combinations. In some examples, the mesh recommendation device performs the process 1400 as part of generating a network performance score for each of the plurality of AP placement combinations as discussed in relation to block 1330 described with reference to FIG. 13. The operations of the process 1400 may be implemented by a mesh recommendation device or its components as described herein. For example, the process 1400 may be performed by a wireless communication device, such as the recommendation device 1600 described with reference to FIG. 16, operating as or within a mesh recommendation device. In some examples, the process 1400 may be performed by a mesh recommendation device such as one of the STAs 104 described with reference to FIG. 1 or the mesh recommendation device 220 described with reference to FIGS. 2 and 3.

In some examples, in block 1405, the mesh recommendation device selects an unscored AP placement combination of the plurality of AP placement combinations.

In some examples, in block 1410, the mesh recommendation device estimates a number of clients able to connect to the wireless network when the unscored AP placement combination is deployed in the physical service environment.

In some examples, in block 1415, the mesh recommendation device estimates end-to-end traffic performance for the number of clients. In some implementations, the mesh recommendation device 220 may use the processes described in relation to block 1065 of FIG. 10 to estimate the E2E traffic capacity and performance for each of the client nodes in a given AP placement combination.

In some examples, in block 1420, the mesh recommendation device estimates an overall network traffic throughput. For example, the mesh recommendation device 220 may estimate or test a throughput of each link or connection including client to mesh connections and mesh connections in the AP placement combination.

In some examples, in block 1425, the mesh recommendation device generates the network performance score for the unscored AP placement combination using the number of clients, the end-to-end traffic performance and the overall network traffic throughput. In some examples, the various network performance scores generated for each of the plurality of AP placement combinations may be used to select an AP placement combination as discussed in relation to block 1335 described with reference to FIG. 13

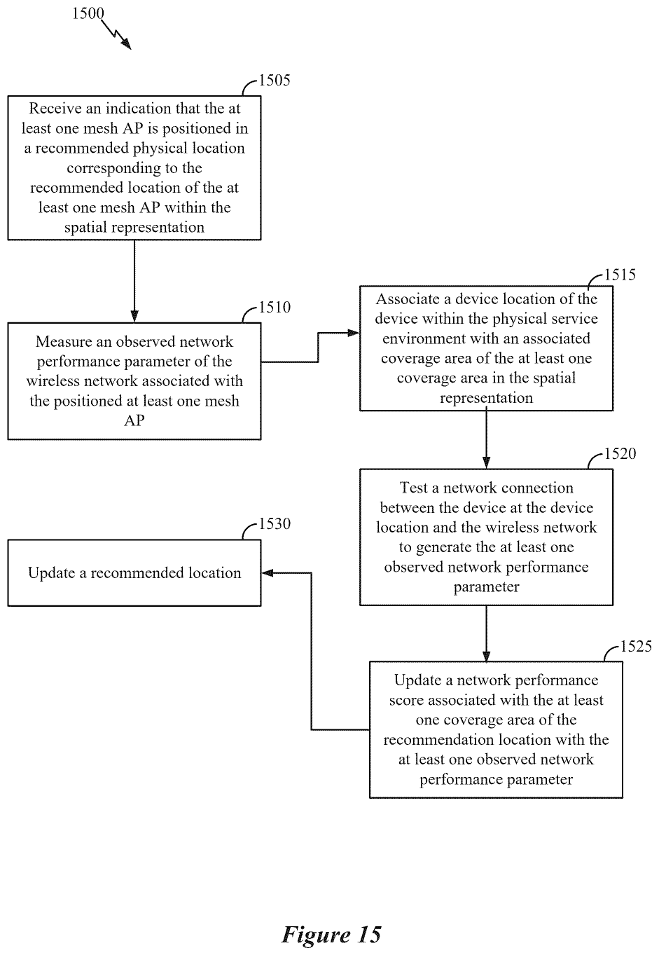

FIG. 15 shows a flowchart illustrating an example process 1500 performable by or at a device that supports providing a mesh AP placement recommendation for a wireless mesh network. In some examples, the mesh recommendation device performs the process 1500 as part of a measure and refinement process for AP placement locations as discussed in relation to block 365 described with reference to FIG. 3. For example, the mesh recommendation device may perform the process 1500 as part of refining recommend locations for at least one mesh AP outputted at block 1220 of the process 1200 described with reference to FIG. 12. The operations of the process 1500 may be implemented by a mesh recommendation device or its components as described herein. For example, the process 1500 may be performed by a wireless communication device, such as the recommendation device 1600 described with reference to FIG. 16, operating as or within a mesh recommendation device. In some examples, the process 1500 may be performed by a mesh recommendation device such as one of the STAs 104 described with reference to FIG. 1 or the mesh recommendation device 220 described with reference to FIGS. 2 and 3.

In some examples, in block 1505, the mesh recommendation device receives an indication that the at least one mesh AP is positioned in a recommended physical location corresponding to the recommended location of the at least one mesh AP within the spatial representation. For example, upon outputting the recommendation locations at block 1220, the mesh recommendation device may begin waiting for an indication that a mesh AP has been placed in the wireless network environment. For example, when a mesh AP, including a root AP or a repeater AP connects to the wireless mesh network 205, the mesh recommendation device 220 may receive an indication from the wireless mesh network 205 that a new node has been placed and is online. In another example, the user 225 may also indicate to the mesh recommendation device 220 that the user has placed and powered on a mesh node.

In some examples, in block 1510, the mesh recommendation device measures at least one observed network performance parameter of the wireless network associated with the positioned at least one mesh AP. In some examples, the network performance parameter may include any of a Received Signal Strength Indicator (RSSI) measurement, available wireless channels in the wireless network, a number of devices connected to the wireless network, and network traffic demand of connected devices. In some examples, the measure process of block 1510 includes the processes described in blocks 1515-1525.

In some examples, in block 1515, the mesh recommendation device associates a device location of the device within the physical service environment with an associated coverage area of the at least one coverage area in the spatial representation. For example, the mesh recommendation device 220 may associate its location during the measure process in block 1510 with a measure location 820 as described in FIG. 8 or other location in the spatial representation 510.

In some examples, in block 1520, the mesh recommendation device tests a network connection between the device at the device location and the wireless network to generate the at least one observed network performance parameter. For example, the mesh recommendation device 220 may locate at a measure location 820 to test the network connections 830 and 835 in the wireless mesh network 205.

In some examples, in block 1525, the mesh recommendation device updates a network performance score associated with the at least one coverage area of the recommendation location with the at least one observed network performance parameter. For example, if the mesh recommendation device 220 measures a different value for any of the network performance parameters or other network score factors than the expected value in the AP placement combination 650, the mesh recommendation device 220 updates the theoretical value with the observed value and may return to process 1300, described in FIG. 13, to update the recommended location, including the AP placement combination.

In some examples, in block 1530, the mesh recommendation device updates the recommended location. In some examples, the update process may include updating the recommended location of the at least one mesh AP within the spatial representation based at least in part on the observed network performance parameter. For example, as shown in FIG. 9, the mesh recommendation device 220 may recommend moving a repeater AP to a new location 920. In another example, the updated recommendation location may include information indicating another recommended location of another mesh AP within the spatial representation based at least in part on the observed network performance parameter. For example, as shown in FIG. 9, the updated recommendation may include a recommendation to add a new mesh AP 930 to the wireless mesh network 205 in order to improve the network coverage and performance.

FIG. 16 shows a block diagram of an example recommendation device 1600 that supports providing a mesh AP placement recommendation for a wireless mesh network. In some examples, the recommendation device 1600 is configured to perform the processes 1000-1500 described with reference to FIGS. 10-15. The recommendation device 1600 may include one or more chips, SoCs, chipsets, packages, components or devices that individually or collectively constitute or include a processing system. The processing system may interface with other components of the recommendation device 1600 and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1600 may transmit the information output from the chip. In such an example, the second interface may refer to an interface between the processing system of the chip and a reception component, such that the device 1600 may receive information that is passed to the processing system. In some such examples, the first interface also may obtain information, such as from the transmission component, and the second interface also may output information, such as to the reception component.

The processing system of the recommendation device 1600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform or cause to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the recommendation device 1600 can be configurable or configured for use in an AP, such as the AP 102 described with reference to FIG. 1. In some other examples, the recommendation device 1600 can be an AP that includes such a processing system and other components including multiple antennas. The recommendation device 1600 is capable of transmitting and receiving wireless communications in the form of, for example, wireless packets. For example, the recommendation device 1600 can be configurable or configured to transmit and receive packets in the form of physical layer PPDUs and MPDUs conforming to one or more of the IEEE 802.11 family of wireless communication protocol standards. In some other examples, the recommendation device 1600 can be configurable or configured to transmit and receive signals and communications conforming to one or more 3GPP specifications including those for 5G NR or 6G. In some examples, the recommendation device 1600 also includes or can be coupled with one or more application processors which may be further coupled with one or more other memories. In some examples, the recommendation device 1600 further includes at least one external network interface coupled with the processing system that enables communication with a core network or backhaul network that enables the recommendation device 1600 to gain access to external networks including the Internet.

Portions of one or more of the components 1605-1620 may be implemented at least in part in hardware or firmware. For example, the components 1615 and 1620 may be implemented at least in part by a processor or a modem. In some examples, portions of one or more of the components 1615 and 1620 may be implemented at least in part by a processor and software in the form of processor-executable code stored in a memory.

Implementation examples are described in the following numbered clauses:

Clause 1. A device, including: a processing system that includes one or more processors and one or more memories coupled with the one or more processors, the processing system configured to cause the device to: receive sensor data based on a scan of a physical service environment using at least one optical sensor associated with the device, a spatial representation representing the physical service environment being generated based on the sensor data; receive information indicating at least one candidate node location in the spatial representation for a root access point (AP) of a wireless network; receive information indicating at least one coverage area for the wireless network within the spatial representation; and output information indicating a recommended location of at least one mesh AP of the wireless network within the spatial representation, where the recommended location of the at least one mesh AP of the wireless network within the spatial representation is based at least in part on the at least one candidate node location of the root AP, the at least one coverage area for the wireless network, and physical properties of the physical service environment.

Clause 2. The device of clause 1, where the processing system is further configured to cause the device to: scan the physical service environment, using the at least one optical sensor associated with the device, to collect the sensor data representing the physical service environment; and generate the spatial representation for the physical service environment using the sensor data.

Clause 3. The device of clause 1, where the at least one optical sensor includes one or more of: a light detection and ranging (LIDAR) sensor; or image sensor.

Clause 4. The device of clause 1, where the spatial representation for the physical service environment includes representations of one or more of: candidate locations to connect to a wide area network (WAN); candidate power source locations; or physical obstacles.

Clause 5. The device of clause 4, where the processing system is further configured to cause the device to: receive information indicating expected areas of high wireless network demand, where candidate client anchor locations are added to the spatial representation based on the expected areas of high wireless network demand, and where the recommended location of the at least one mesh AP is based at least in part on the expected areas of high wireless network demand.

Clause 6. The device of clause 1, where to determine the recommended location of the at least one mesh AP the processing system is further configured to cause the device to: select, using service factors for the wireless network, a set of placement parameters for positioning the at least one mesh AP in the physical service environment; generate, using the set of placement parameters, the at least one coverage area, and physical properties of the physical service environment, a plurality of AP placement combinations, where each AP placement combination includes a location in the spatial representation for the root AP and the at least one mesh AP; generate a network performance score for each of the plurality of AP placement combinations; and select an AP placement combination with a highest network performance score as an AP placement configuration for the physical service environment, where the AP placement configuration with the highest network performance score includes the recommended location of the at least one mesh AP within the spatial representation.

Clause 7. The device of clause 6, where to generate the plurality of AP placement combinations the processing system is further configured to cause the device to: select a root node AP location for a first AP placement combination of the plurality of AP placement combinations using the candidate root node locations and candidate power source locations; and select at least one repeater node AP location for the first AP placement combination using the candidate power source locations and candidate client anchor locations.

Clause 8. The device of clause 6, where to generate the network performance score for each of the plurality of AP placement combinations the processing system is further configured to cause the device to: select an unscored AP placement combination of the plurality of AP placement combinations; estimate a number of clients able to connect to the wireless network when the unscored AP placement combination is deployed in the physical service environment; estimate end-to-end traffic performance for the number of clients; estimate an overall network traffic throughput; and generate the network performance score for the unscored AP placement combination using the number of clients, the end-to-end traffic performance and the overall network traffic throughput.

Clause 9. The device of clause 1, where the recommended location of the at least one mesh AP within the spatial representation is further based at least in part on at least one of: an expected number of client devices connected to the wireless network; an expected overall network traffic demand for the wireless network; an expected network traffic demand for one or more client devices connected to the wireless network; or a number of mesh APs available for placement in the physical service environment.

Clause 10. The device of clause 1, the processing system is further configured to cause the device to: receive a selection of a placement parameter preference for the wireless network, where the placement parameter preference includes one or more of: select mesh AP candidate locations that increase a minimum throughput for an expected overall network traffic demand for the wireless network; select mesh AP candidate locations that increase a capacity of client devices connected to the wireless network; select mesh AP candidate locations that satisfy an expected network traffic demand for the one or more client devices connected to the wireless network; select mesh AP candidate locations that utilize a number of mesh APs for placement in the physical service environment; or exclude mesh AP candidate locations that create constrained network traffic pathways, where the recommended location of the at least one mesh AP is based at least in part on the placement parameter preference.

Clause 11. The device of clause 1, where the processing system is further configured to cause the device to: receive an indication that the at least one mesh AP is positioned in a recommended physical location corresponding to the recommended location of the at least one mesh AP within the spatial representation; measure at least one observed network performance parameter of the wireless network associated with the positioned at least one mesh AP; and at least one of: update the recommended location of the at least one mesh AP within the spatial representation based at least in part on the observed network performance parameter, or output information indicating another recommended location of another mesh AP within the spatial representation based at least in part on the observed network performance parameter.

Clause 12. The device of clause 11, where measuring at least one network performance parameter of the wireless network associated with the positioned at least one mesh AP includes: associate a device location of the device within the physical service environment with an associated coverage area of the at least one coverage area in the spatial representation; test a network connection between the device at the device location and the wireless network to generate the at least one observed network performance parameter; and update a network performance score associated with the at least one coverage area of the recommendation location with the at least one observed network performance parameter.

Clause 13. The device of clause 11, where the at least one network performance parameter includes one or more of: a Received Signal Strength Indicator (RSSI) measurement; available wireless channels in the wireless network; a number of devices connected to the wireless network; and network traffic demand of connected devices.

Clause 14. A method, including: receiving sensor data based on a scan of a physical service environment using at least one optical sensor associated with a device, a spatial representation representing the physical service environment being generated based on the sensor data; receiving information indicating at least one candidate node location in the spatial representation for a root access point (AP) of a wireless network; receiving information indicating at least one coverage area for the wireless network within the spatial representation; and outputting information indicating a recommended location of at least one mesh AP of the wireless network within the spatial representation, where the recommended location of the at least one mesh AP of the wireless network within the spatial representation is based at least in part on the at least one candidate node location of the root AP, the at least one coverage area for the wireless network, and physical properties of the physical service environment.

Clause 15. The method of clause 14, where determining the recommended location of the at least one mesh AP further includes: selecting, using service factors for the wireless network, a set of placement parameters for positioning the at least one mesh AP in the physical service environment; generating, using the set of placement parameters, the at least one coverage area, and physical properties of the physical service environment, a plurality of AP placement combinations, where each AP placement combination includes a location in the spatial representation for the root AP and the at least one mesh AP; generating a network performance score for each of the plurality of AP placement combinations; and selecting an AP placement combination with a highest network performance score as an AP placement configuration for the physical service environment, where the AP placement configuration with the highest network performance score includes the recommended location of the at least one mesh AP within the spatial representation.

Clause 16. The method of clause 15, where generating the plurality of AP placement combinations further includes: selecting a root node AP location for a first AP placement combination of the plurality of AP placement combinations using the candidate root node locations and candidate power source locations; and selecting at least one repeater node AP location for the first AP placement combination using the candidate power source locations and candidate client anchor locations.

Clause 17. The method of clause 16, where generating the network performance score for each of the plurality of AP placement combinations further includes: selecting an unscored AP placement combination of the plurality of AP placement combinations; estimating a number of clients able to connect to the wireless network when the unscored AP placement combination is deployed in the physical service environment; estimating end-to-end traffic performance for the number of clients; estimating an overall network traffic throughput; and generating the network performance score for the unscored AP placement combination using the number of clients, the end-to-end traffic performance and the overall network traffic throughput.

Clause 18. The method of clause 14, further including: receiving a selection of a placement parameter preference for the wireless network, where the placement parameter preference includes one or more of: select mesh AP candidate locations that increase a minimum throughput for an expected overall network traffic demand for the wireless network; select mesh AP candidate locations that increase a capacity of client devices connected to the wireless network; select mesh AP candidate locations that satisfy an expected network traffic demand for the one or more client devices connected to the wireless network; select mesh AP candidate locations that utilize a number of mesh APs for placement in the physical service environment; or exclude mesh AP candidate locations that create constrained network traffic pathways, where the recommended location of the at least one mesh AP is based at least in part on the placement parameter preference.

Clause 19. The method of clause 14, further including: receiving an indication that the at least one mesh AP is positioned in a recommended physical location corresponding to the recommended location of the at least one mesh AP within the spatial representation; measuring at least one observed network performance parameter of the wireless network associated with the positioned at least one mesh AP; and at least one of: updating the recommended location of the at least one mesh AP within the spatial representation based at least in part on the observed network performance parameter, or outputting information indicating another recommended location of another mesh AP within the spatial representation based at least in part on the observed network performance parameter.

Clause 20. A non-transitory processor-readable medium having stored thereon processor executable instructions configured to cause a processing device in a computing device to perform operations including: receiving sensor data based on a scan of a physical service environment using at least one optical sensor associated with a device, a spatial representation representing the physical service environment being generated based on the sensor data; receiving information indicating at least one candidate node location in the spatial representation for a root access point (AP) of a wireless network; receiving information indicating at least one coverage area for the wireless network within the spatial representation; and outputting information indicating a recommended location of at least one mesh AP of the wireless network within the spatial representation, where the recommended location of the at least one mesh AP of the wireless network within the spatial representation is based at least in part on the at least one candidate node location of the root AP, the at least one coverage area for the wireless network, and physical properties of the physical service environment.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A device, comprising:
a processing system that includes one or more processors and one or more memories coupled with the one or more processors, the processing system configured to cause the device to:
receive sensor data based on a scan of a physical service environment using at least one optical sensor associated with the device,
a spatial representation representing the physical service environment being generated based on the sensor data;
receive information indicating at least one candidate node location in the spatial representation for a root access point (AP) of a wireless network;
receive information indicating at least one coverage area for the wireless network within the spatial representation; and
output information indicating a recommended location of at least one mesh AP of the wireless network within the spatial representation,
wherein the recommended location of the at least one mesh AP of the wireless network within the spatial representation is based at least in part on the at least one candidate node location of the root AP, the at least one coverage area for the wireless network, and physical properties of the physical service environment.

2. The device of claim 1, wherein the processing system is further configured to cause the device to:
scan the physical service environment, using the at least one optical sensor associated with the device, to collect the sensor data representing the physical service environment; and
generate the spatial representation for the physical service environment using the sensor data.

3. The device of claim 1, wherein the at least one optical sensor comprises one or more of:
a light detection and ranging (LIDAR) sensor; or
image sensor.

4. The device of claim 1, wherein the spatial representation for the physical service environment comprises representations of one or more of:
candidate locations to connect to a wide area network (WAN);
candidate power source locations; or
physical obstacles.

5. The device of claim 4, wherein the processing system is further configured to cause the device to:
receive information indicating expected areas of high wireless network demand,
wherein candidate client anchor locations are added to the spatial representation based on the expected areas of high wireless network demand, and
wherein the recommended location of the at least one mesh AP is based at least in part on the expected areas of high wireless network demand.

6. The device of claim 1, wherein to determine the recommended location of the at least one mesh AP the processing system is further configured to cause the device to:
select, using service factors for the wireless network, a set of placement parameters for positioning the at least one mesh AP in the physical service environment;
generate, using the set of placement parameters, the at least one coverage area, and physical properties of the physical service environment, a plurality of AP placement combinations, where each AP placement combination comprises a location in the spatial representation for the root AP and the at least one mesh AP;
generate a network performance score for each of the plurality of AP placement combinations; and
select an AP placement combination with a highest network performance score as an AP placement configuration for the physical service environment,
wherein the AP placement configuration with the highest network performance score includes the recommended location of the at least one mesh AP within the spatial representation.

7. The device of claim 6, wherein to generate the plurality of AP placement combinations the processing system is further configured to cause the device to:
select a root node AP location for a first AP placement combination of the plurality of AP placement combinations using the candidate root node locations and candidate power source locations; and
select at least one repeater node AP location for the first AP placement combination using the candidate power source locations and candidate client anchor locations.

8. The device of claim 6, wherein to generate the network performance score for each of the plurality of AP placement combinations the processing system is further configured to cause the device to:
select an unscored AP placement combination of the plurality of AP placement combinations;
estimate a number of clients able to connect to the wireless network when the unscored AP placement combination is deployed in the physical service environment;
estimate end-to-end traffic performance for the number of clients;
estimate an overall network traffic throughput; and
generate the network performance score for the unscored AP placement combination using the number of clients, the end-to-end traffic performance and the overall network traffic throughput.

9. The device of claim 1, wherein the recommended location of the at least one mesh AP within the spatial representation is further based at least in part on at least one of:
an expected number of client devices connected to the wireless network;
an expected overall network traffic demand for the wireless network;
an expected network traffic demand for one or more client devices connected to the wireless network; or
a number of mesh APs available for placement in the physical service environment.

10. The device of claim 1, the processing system is further configured to cause the device to:
receive a selection of a placement parameter preference for the wireless network, wherein the placement parameter preference includes one or more of:
select mesh AP candidate locations that increase a minimum throughput for an expected overall network traffic demand for the wireless network;
select mesh AP candidate locations that increase a capacity of client devices connected to the wireless network;
select mesh AP candidate locations that satisfy an expected network traffic demand for the one or more client devices connected to the wireless network;
select mesh AP candidate locations that utilize a number of mesh APs for placement in the physical service environment; or
exclude mesh AP candidate locations that create constrained network traffic pathways,
wherein the recommended location of the at least one mesh AP is based at least in part on the placement parameter preference.

11. The device of claim 1, wherein the processing system is further configured to cause the device to:
receive an indication that the at least one mesh AP is positioned in a recommended physical location corresponding to the recommended location of the at least one mesh AP within the spatial representation;
measure at least one observed network performance parameter of the wireless network associated with the positioned at least one mesh AP; and
at least one of:
update the recommended location of the at least one mesh AP within the spatial representation based at least in part on the observed network performance parameter, or
output information indicating another recommended location of another mesh AP within the spatial representation based at least in part on the observed network performance parameter.

12. The device of claim 11, wherein measuring at least one network performance parameter of the wireless network associated with the positioned at least one mesh AP comprises:
associate a device location of the device within the physical service environment with an associated coverage area of the at least one coverage area in the spatial representation;
test a network connection between the device at the device location and the wireless network to generate the at least one observed network performance parameter; and
update a network performance score associated with the at least one coverage area of the recommendation location with the at least one observed network performance parameter.

13. The device of claim 11, wherein the at least one network performance parameter comprises one or more of:
a Received Signal Strength Indicator (RSSI) measurement;
available wireless channels in the wireless network;
a number of devices connected to the wireless network; and
network traffic demand of connected devices.

14. A method, comprising:
receiving sensor data based on a scan of a physical service environment using at least one optical sensor associated with a device,
a spatial representation representing the physical service environment being generated based on the sensor data;
receiving information indicating at least one candidate node location in the spatial representation for a root access point (AP) of a wireless network;
receiving information indicating at least one coverage area for the wireless network within the spatial representation; and
outputting information indicating a recommended location of at least one mesh AP of the wireless network within the spatial representation,
wherein the recommended location of the at least one mesh AP of the wireless network within the spatial representation is based at least in part on the at least one candidate node location of the root AP, the at least one coverage area for the wireless network, and physical properties of the physical service environment.

15. The method of claim 14, wherein determining the recommended location of the at least one mesh AP further comprises:
selecting, using service factors for the wireless network, a set of placement parameters for positioning the at least one mesh AP in the physical service environment;
generating, using the set of placement parameters, the at least one coverage area, and physical properties of the physical service environment, a plurality of AP placement combinations, where each AP placement combination comprises a location in the spatial representation for the root AP and the at least one mesh AP;
generating a network performance score for each of the plurality of AP placement combinations; and
selecting an AP placement combination with a highest network performance score as an AP placement configuration for the physical service environment,
wherein the AP placement configuration with the highest network performance score includes the recommended location of the at least one mesh AP within the spatial representation.

16. The method of claim 15, wherein generating the plurality of AP placement combinations further comprises:
selecting a root node AP location for a first AP placement combination of the plurality of AP placement combinations using the candidate root node locations and candidate power source locations; and
selecting at least one repeater node AP location for the first AP placement combination using the candidate power source locations and candidate client anchor locations.

17. The method of claim 16, wherein generating the network performance score for each of the plurality of AP placement combinations further comprises:
selecting an unscored AP placement combination of the plurality of AP placement combinations;
estimating a number of clients able to connect to the wireless network when the unscored AP placement combination is deployed in the physical service environment;
estimating end-to-end traffic performance for the number of clients;
estimating an overall network traffic throughput; and
generating the network performance score for the unscored AP placement combination using the number of clients, the end-to-end traffic performance and the overall network traffic throughput.

18. The method of claim 14, further comprising:
receiving a selection of a placement parameter preference for the wireless network, wherein the placement parameter preference includes one or more of:
select mesh AP candidate locations that increase a minimum throughput for an expected overall network traffic demand for the wireless network;
select mesh AP candidate locations that increase a capacity of client devices connected to the wireless network;
select mesh AP candidate locations that satisfy an expected network traffic demand for the one or more client devices connected to the wireless network;
select mesh AP candidate locations that utilize a number of mesh APs for placement in the physical service environment; or
exclude mesh AP candidate locations that create constrained network traffic pathways,
wherein the recommended location of the at least one mesh AP is based at least in part on the placement parameter preference.

19. The method of claim 14, further comprising:
receiving an indication that the at least one mesh AP is positioned in a recommended physical location corresponding to the recommended location of the at least one mesh AP within the spatial representation;
measuring at least one observed network performance parameter of the wireless network associated with the positioned at least one mesh AP; and
at least one of:
updating the recommended location of the at least one mesh AP within the spatial representation based at least in part on the observed network performance parameter, or
outputting information indicating another recommended location of another mesh AP within the spatial representation based at least in part on the observed network performance parameter.

20. A non-transitory processor-readable medium having stored thereon processor executable instructions configured to cause a processing device in a computing device to perform operations comprising:
receiving sensor data based on a scan of a physical service environment using at least one optical sensor associated with a device,
a spatial representation representing the physical service environment being generated based on the sensor data;
receiving information indicating at least one candidate node location in the spatial representation for a root access point (AP) of a wireless network;
receiving information indicating at least one coverage area for the wireless network within the spatial representation; and
outputting information indicating a recommended location of at least one mesh AP of the wireless network within the spatial representation,
wherein the recommended location of the at least one mesh AP of the wireless network within the spatial representation is based at least in part on the at least one candidate node location of the root AP, the at least one coverage area for the wireless network, and physical properties of the physical service environment.
